(19) United States
(12) Patent Application Publication
(10) Pub. No.: US 2024/0101876 A1
(43) Pub. Date: Mar. 28, 2024

(54) A WATER-BASED HUMIDITY RESISTANT ADHESIVE COMPOSITION, PROCESS FOR PREPARING AND USING THE SAME

(71) Applicant: Arkema France, Colombes (FR)

(72) Inventors: Jiqiang XIA, Dublin, OH (US); Randy Allen JOHNSON, Dublin, OH (US)

(21) Appl. No.: 18/266,821

(22) PCT Filed: Dec. 13, 2021
(86) PCT No.: PCT/US2021/063011

§ 371 Date: Jun. 13, 2023

Related U.S. Application Data
(60) Provisional application No. 63/125,849, filed on Dec. 15, 2020.

(51) Int. Cl. C09J 133/08; C09J 11/08

(52) U.S. Cl. CPC C09J 133/08; C09J 11/08; C09J 2301/312; C09J 2301/408; C09J 2301/414

(57) ABSTRACT

A water-based humidity resistant adhesive compositions comprising (i) about 30 wt % to about 80 wt % of an acrylic copolymer emulsion and (ii) about 2 wt % to about 40 wt % of an adhesion promoter of a water-based chlorinated or maleic anhydride modified polyolefin. The adhesive effectively bonds a sheet membrane to a substrate of steel, wood, concrete, a roof board, insulation, or a fiberglass mat. Also disclosed is a method of bonding the sheet membrane, such as TPO, to a substrate with the adhesive composition, and a method of preparing the adhesive composition.

### FIELD OF THE INVENTION

The presently disclosed process(es), procedure(s), method(s), product(s), result(s), and/or concept(s) (collectively referred to hereinafter as the “present disclosure or invention”) relates generally to a water-based humidity resistant adhesive composition for bonding a sheet membrane to a substrate of steel, wood, concrete, a roofing board, insulation, or a fiberglass mat roof board, a method of bonding the membrane to the substrate with the composition, and a method of preparing the composition.

### BACKGROUND OF THE INVENTION

Polymeric membranes, such as cured sheets of ethylene-propylene-diene copolymer rubber (EPDM) or extruded sheet of thermoplastic olefins (TPO), are often used in the construction industry to cover flat or low-sloped roofs. These membranes, sometimes referred to as panels, are typically delivered to a construction site in a bundled roll, transferred to the roof, and then unrolled and positioned. The sheets are then affixed to the building structure by employing varying techniques such as mechanical fastening, ballasting, and/or adhesively adhering the membrane to the roof. The roof substrate to which the membrane is secured may include a variety of materials depending on the situation. For example, the surface may be concrete, metal, a wood deck, and it may include insulation or facer board, and/or it may include an existing membrane.

In addition to securing the membrane to the roof—which mode of attachment primarily seeks to prevent wind uplift—the individual membrane panels, together with flashing and other accessories, are positioned and adjoined to achieve a waterproof barrier on the roof. Typically, the edges of adjoining panels are overlapped, and these overlapping portions are adjoined to one another through a number of methods depending upon the membrane materials and exterior conditions. One approach involves providing adhesives or adhesive tapes between the overlapping portions, thereby creating a water-resistant, seal.

Adhesive attachment is typically employed to form adhered roofing systems. The membrane may be adhered to the roof substrate substantially across the entire planar surface of the membrane to form fully adhered systems. In other words, a majority, if not all, of the membrane panel is secured to the roof substrate as opposed to mechanical attachment methods which can only achieve direct attachment, in those locations where a mechanical fastener actually affixes the membrane. Fully adhered roofing systems are advantageously installed where maximum wind uplift prevention is desired. Also, fully adhered systems are desirable in re-roofing situations, especially where the new membrane is placed over an existing membrane (a technique that is commonly referred to as re-skinning).

One technique employs a water-borne bond adhesive that is applied to the substrate and then the EPDM or TPO membrane can be applied to the adhesive layer. While this attachment technique has proven useful, the use is generally limited to ambient weather conditions (e.g., greater than about 40° F.) and/or in conjunction with porous substrates that absorb water thereby allowing the adhesive to dry or cure without blistering the membrane.

In other situations, solvent-based adhesives are employed, such as polychloroprene-based bond adhesives. While the use of known solvent-based adhesives has proven versatile to the extent that the substrate need not be porous and cold-weather application is feasible, the technique requires application of the adhesive to both the substrate and the membrane, followed by a time delay to allow the solvent to flash off, and then a mating of the two adhesive surfaces (i.e., the adhesive coated membrane is mated to the adhesive coated membrane).

While both solvent-based and water-based adhesives may be used as contact adhesives, solvent-based bonding adhesives offer advantages. For example, the flash-off period, which is the time required to allow solvent evaporation prior to mating, can be between 5 and 40 minutes, and is less susceptible to environmental conditions, such as temperature, than water-based adhesive systems. Current solvent-based adhesives possess wide application windows, appropriate drying performance and good bonding properties. However, they use VOC solvents to dissolve the polymers, usually rubber materials. As the industry moves towards “green” roofing, the VOC solvents in the bonding adhesives have to be replaced with non-VOC materials.

“Wet-lay-in” refers to an application method to bond a roofing membrane to a substrate, where the adhesive is applied to the substrate only, then joined to the membrane while the adhesive is still wet. There is advantageously no required drying or waiting period during this process. This is opposite to the traditional method of using adhesives in commercial roofing, where the adhesive, either solvent-based or water-based, is used as a contact adhesive, applied onto both sides of membrane and substrate, waiting for evaporation of water and/or solvents until the adhesive is tacky, then joining the membrane and substrate. It has been estimated that in some commercial roofing projects, labor is about 70% of the total job cost. Thus, labor cost saving is highly desirable. The wet-lay-in method greatly speeds up the process and reduces labor cost and time significantly.

Current approaches to eliminate TOC solvents have not created a solution that can provide the same applications and adhesion properties as conventional solvent-based bonding adhesive. Thus, there is therefore a need in the art for a bond adhesive which uses non-VOC-based solvents which provides the same applications and adhesion properties as conventional solvent-based bonding adhesive. One-sided, wet lay-in, water-based adhesives useful for bonding smooth PVC membranes to various substrates are commercially available in the market. However, these are not adequate for TPO membranes.

Currently, there are traditional water based (WB) TPO contact adhesives on the market but they have disadvantages and do not function adequately as a wet-lay-in adhesive. Therefore, an improved WB wet-lay-in adhesive technology in the roofing industry for TPO membranes would be highly desirable and beneficial to customers.

U.S. Pat. No. 5,520,957 discloses a method of preparing a coated abrasive article containing a pressure-sensitive adhesive.

U.S. Pat. No. 4,548,845 discloses a normally tacky, pressure-sensitive adhesive when deposited on a substrate comprising a mixture of non-volatile components.

U.S. Publication No. 2005/0282961 discloses an acrylic emulsion based polymer pressure sensitive adhesive comprising a vinyl acetate polymer present in an amount from about 1 to 10% by weight.

U.S. Pat. No. 6,066,688 discloses a water-based adhesive composition comprising a mixture consisting of from about 50 to about 80 parts by weight of a water-based acrylic adhesive emulsion; and from about 50 to 20 parts by weight of tackifier; wherein both the adhesive composition and the mixture have above about 70 percent of solids before drying.

Hence, there is a need in the roofing industry for improved water-based adhesive compositions for bonding roofing membranes to substrates by “wet-lay-in” methods to speed up the roofing process and significantly reduce labor costs.

### SUMMARY OF THE INVENTION

The present disclosure provides a water-based humidity resistant adhesive composition for bonding a sheet membrane to a substrate of steel, a wood, a concrete, a roof board, insulation, a fiberglass mat roof board and the like. Also provided is a method of bonding a sheet material to a substrate with the adhesive composition, and a method of preparing the adhesive composition.

One objective of the present disclosure relates to a water-based humidity resistant adhesive composition comprising: (i) about 30 wt % to about 80 wt % of an acrylic copolymer emulsion; (ii) about 2 wt % to about 40 wt % of an adhesion promoter of a water-based chlorinated or maleic anhydride modified polyolefin; (iii) about 0 wt % to about 25 wt % of carboxylated styrene-butadiene emulsion; and (iv) about 0 wt % to about 55 wt % of at least one additive.

Another objective of the present disclosure relates to a water-based humidity resistant adhesive composition comprising: (i) about 30 wt % to about 80 wt % of an acrylic copolymer comprising monomers of C₂-C₂₀ alkyl acrylates, C₂-C₂₀ alkyl methacrylates and vinyl acetate; (ii) about 2 wt % to about 40 wt % of an adhesion promoter of a water-based chlorinated or maleic anhydride modified polyolefin; (iii) about 0 wt % to about 25 wt % of carboxylated styrene-butadiene emulsion; and (iv) about 0 wt % to about 55 wt % of at least one additive.

Another objective of the present disclosure relates to a water-based humidity resistant adhesive composition comprising: (i) about 30 wt % to about 80 wt % of an acrylic copolymer comprising monomers in the range of from about 60 wt % to about 98 wt % of 2-ethylhexyl acrylate, from about 1 wt % to about 15 wt % vinyl acetate, and from about 1 wt % to about 15 wt % methyl methacrylate; (ii) about 2 wt % to about 40 wt % of an adhesion promoter of a water-based chlorinated or maleic anhydride modified polyolefin; (iii) about 0 wt % to about 25 wt % of carboxylated styrene-butadiene emulsion; and (iv) about 0 wt % to about 55 wt % of at least one additive.

One more objective of the present disclosure relates to a water-based humidity resistant adhesive composition comprising: (i) about 30 wt % to about 80 wt % of an acrylic copolymer comprising monomers in the range of from about 60 wt % to about 98 wt % of 2-ethylhexyl acrylate, from about 1 wt % to about 15 wt % vinyl acetate, and from about 1 wt % to about 15 wt % methyl methacrylate; (ii) about 2 wt % to about 40 wt % of an adhesion promoter of a water-based chlorinated or maleic anhydride modified polyolefin; (iii) about 0 wt % to about 25 wt % of carboxylated styrene-butadiene emulsion; and (iv) about 0 wt % to about 55 wt % of at least one additive.

Another objective of the present disclosure relates to a method of bonding a sheet membrane to a substrate comprising: applying a water-based humidity resistant adhesive composition to the substrate, said water based adhesive composition comprising: (i) about 30 wt % to about 80 wt % of an acrylic copolymer emulsion; (ii) about 2 wt % to about 40 wt % of an adhesion promoter of a water-based chlorinated or maleic anhydride modified polyolefin; (iii) about 0 to about 25 wt % of carboxylated styrene-butadiene emulsion; and (iv) about 0 wt % to about 55 wt % at least one additive, and bringing the sheet membrane and the substrate in simultaneous contact with the water based adhesive composition to bond the sheet membrane to the substrate.

Another objective of the present disclosure relates to a method of bonding a sheet membrane to a substrate comprising: applying a water-based humidity resistant adhesive composition to the substrate, said water based adhesive composition comprising: (i) about 30 wt % to about 80 wt % of an acrylic copolymer emulsion; (ii) about 2 wt % to about 40 wt % of an adhesion promoter of a water-based chlorinated or maleic anhydride modified polyolefin; about 0 to about 25 wt % of carboxylated styrene-butadiene emulsion; and (iv) about 0 wt % to about 55 wt % of at least one additive, and bringing the sheet membrane and the substrate in simultaneous contact with the water based adhesive composition to bond the sheet membrane to the substrate. The sheet membrane can be selected from the group consisting of weathered thermoplastic polyolefin (TPO), new thermoplastic polyolefin (TPO), patched thermoplastic polyolefin, new modified bitumen, weathered modified bitumen, weathered silicone rubber roof coating, poly propylene and ethylene propylene diene terpolymer rubber (EPDM). The adhesive composition of this invention finds particularly advantageous utility in conjunction with TPO roofing membranes.

One more objective of the present disclosure relates to a process for preparing a water-based humidity resistant adhesive composition, comprising: (i) charging acrylic copolymer emulsion into a reaction container, initiating agitation and mixing; (ii) adding a crosslinking agent, neutralizer or pH adjustment agent to the resultant of step (i) in one or more steps and mixing for at least 10 minutes after each addition; (iii) adding a carboxylated styrene-butadiene emulsion, and an adhesion promoter of a water-based chlorinated or maleic anhydride modified polyolefin to the resultant of step (ii); (iv) adding a tackifier to the resultant of step (iii); (v) adding a pre-blend solution comprising complexed zinc oxide solution and deionized water to the resultant of step (iv); (vi) adding a surfactant to the resultant of step (v); and (vii) adding a rheology modifier to the resultant of step (v) to obtain the water-based humidity resistant adhesive composition.

These and other objects of the present invention will become apparent in light of the following disclosure.

### BRIEF DESCRIPTION OF THE DRAWINGS

It is believed that the present invention will be better understood from the following description taken in conjunction with the accompanying drawings. The referenced drawings are not to be construed as limiting the scope of present invention.

FIG. 1: 180° Peel adhesion of comparative examples at RT (Room Temperature)

FIG. 2: 180° Peel adhesion of comparative examples after humid conditioning

FIG. 3: 180° Peel adhesion of examples of this invention at RT

FIG. 4: 180° Peel adhesion of examples of this invention after humid conditioning

### DETAILED DESCRIPTION OF THE INVENTION

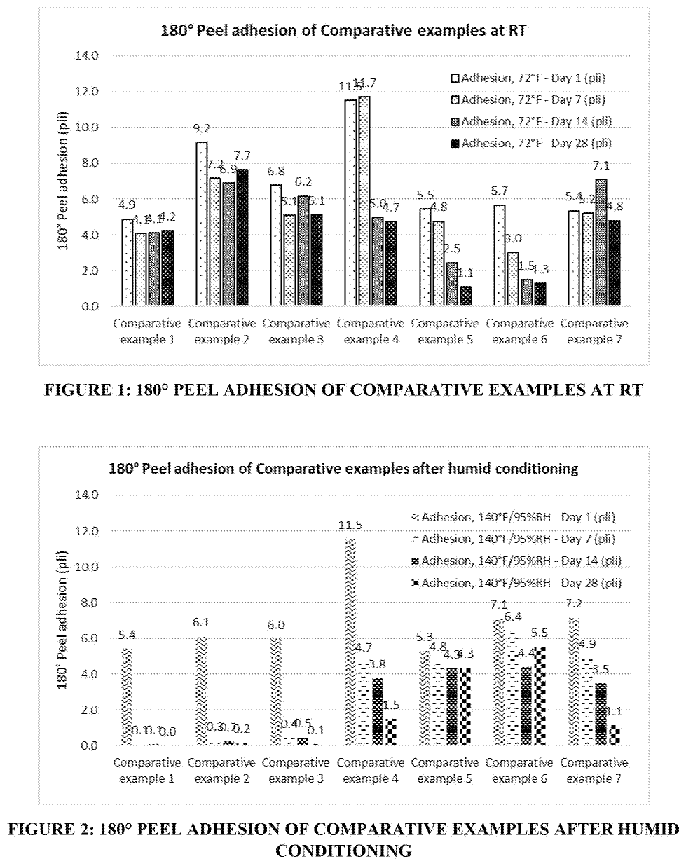

An exemplary embodiment of the invention will now be described with reference to FIGS. 1-4.

Before explaining at least one embodiment of the present disclosure in detail, it is to be understood that the present disclosure is not limited in its application to the details of construction and the arrangement of the components or steps or methodologies set forth in the following description or illustrated in the drawings. The present disclosure is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the present disclosure shall have the meanings that are commonly understood by those of ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which the present disclosure pertains. All patents, published patent applications, and non-patent publications referenced in any portion of this application are herein expressly incorporated by reference in their entirety to the same extent as if each individual patent or publication was specifically and individually indicated to be incorporated by reference.

All of the articles and/or methods disclosed herein can be made and executed without undue experimentation in light of the present disclosure. While the articles and methods of the present disclosure have been described in terms of preferred embodiments, it will be apparent to those of ordinary skill in the art that variations can be applied to the articles and/or methods and in the steps or in the sequence of steps of the method(s) described herein without departing from the concept, spirit and scope of the present disclosure. All such similar substitutes and modifications apparent to those skilled in the art are deemed to be within the spirit, scope and concept of the present disclosure.

As utilized in accordance with the present disclosure, the following terms, unless otherwise indicated, shall be understood to have the following meanings.

The use of the word “a” or “an” when used in conjunction with the term “comprising” can mean “one,” but it is also consistent with the meaning of “one or more,” “at least one,” and “one or more than one.” The use of the term “or” is used to mean “and/or” unless explicitly indicated to refer to alternatives only if the alternatives are mutually exclusive, although the disclosure supports a definition that refers to only alternatives and “and/or.” Throughout this application, the term “about” is used to indicate that a value includes the inherent variation of error for the quantifying device, the method(s) being employed to determine the value, or the variation that exists among the study subjects.

References herein to “one embodiment,” or “one aspect” or “one version” or “one objective” or “another embodiment,” or “another aspect” or “another version” or “another objective” of the invention can include one or more of such embodiment, aspect, version or objective, unless the context clearly dictates otherwise.

The term “at least one” refers to one as well as any quantity more than one, including but not limited to, 1, 2, 3, 4, 5, 10, 15, 20, 30, 40, 50, 100, etc. The term “at least one” can extend up to 100 or 1000 or more depending on the term to which it is attached.

All percentages, parts, proportions, and ratios as used herein are by weight of the total composition, unless otherwise specified. All such weights as they pertain to listed ingredients are based on the active level and therefore do not include solvents or by-products that can be included in commercially available materials, unless otherwise specified.

All references to singular characteristics or limitations of the present invention shall include the corresponding plural characteristics or limitations, and vice-versa, unless otherwise specified or clearly implied to the contrary by the context in which the reference is made.

Numerical ranges as used herein are intended to include every number and subset of numbers contained within that range, whether specifically disclosed or not. Further, these numerical ranges should be construed as providing support for a claim directed to any number or subset of numbers in that range.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. The terms “or combinations thereof” and “and/or combinations thereof” as used herein refer to all permutations and combinations of the listed items preceding the term. For example. “A, B, C, or combinations thereof” is intended to include at least one of: A, B, C, AB, AC, BC, or ABC and, if order is important in a particular context, also BA, CA, CB, CBA, BCA, ACB, BAC, or CAB. Continuing with this example, expressly included are combinations that contain repeats of one or more items or terms, such as BB, AAA, AAB, BBC, AAABCCCC, CBBAAA, CABABB, and so forth. The skilled artisan will understand that typically there is no limit on the number of items or terms in any combination, unless otherwise apparent from the context.

For purposes of the following detailed description, other than in any operating examples, or where otherwise indicated, numbers that express, for example, quantities of ingredients used in the specification and claims are to be understood as being modified in all instances by the term “about”. The numerical parameters set forth in the specification and attached claims are approximations that can vary depending upon the desired properties to be obtained in carrying out the invention.

The term “or combinations thereof”, “and combinations thereof”, and “combinations thereof” as used herein refers to all permutations and combinations of the listed items preceding the term.

The term “about” refers to a range of values ±10% of a specified value. For example, the phrase “about 200” includes ±10% of 200, or from 180 to 220.

The term “polymerization” or “polymerizing” refers to methods for chemically reacting monomer compounds to form polymer chains. The polymer chain can be alternating, blocked, or random. The type of polymerization method can be selected from a wide variety of methods and include the following non-limiting examples: poly condensation, step growth polymerization, and free radical polymerization.

As used herein, the term “wet lay-in method” refers to applying the adhesive to the substrate only, and thereafter with no or virtually no waiting or drying time, applying the sheet membrane to the adhesive substrate immediately thereafter. In comparison, the traditional prior art way of using contact adhesive is to apply adhesive on both substrate and membrane, then wait for solvent or water to evaporate to develop tack (roughly half to 1 hour, depending on ambient conditions), then bonding the two sides together. The wet lay-in method saves significant amounts of time and labor.

As used herein, the term “acrylic polymer” refers to copolymers of acrylic copolymers (block or random) including those polymers that include two or more monomer units of different acrylic monomer units. As used herein, the term acrylic monomer units includes those units that derive from acrylic or alkylacrylic (e.g., methacrylic) monomers.

The term “polymer” as used herein includes, but is not limited to, homopolymers, copolymers, interpolymers, terpolymers, etc. and alloys and blends thereof. Further, as used herein, the term “copolymer” is meant to include polymers having two or more monomers, optionally with other monomers, and may refer to interpolymers, terpolymers, etc. The term “polymer” as used herein also includes impact, block, graft, random and alternating copolymers. The term “polymer” shall further include all possible geometrical configurations unless otherwise specifically stated. Such configurations may include isotactic, syndiotactic and random symmetries.

The term “tackifier” is used herein to refer to an agent that allows the polymer of the composition to be more adhesive by improving wetting during the application. Tackifiers may be produced from petroleum-derived hydrocarbons and monomers of feedstock including tall oil and other polyterpene or resin sources. Tackifying agents are added to give tack to the adhesive and also to modify viscosity. As used herein, the term “tackifier” can include a blend of one or more tackifiers.

As used herein, the term “adhesion promoter” refers to a material that increases the adhesion between a substrate and adhesive composition.

The present disclosure is directed to a water-based humidity resistant adhesive composition comprising (i) about 30 wt % to about 80 wt % of an acrylic copolymer emulsion; (ii) about 2 wt % to about 40 wt % of an adhesion promoter of a water-based chlorinated or maleic anhydride modified polyolefin; (iii) about 0 wt % to about 25 wt % of carboxylated styrene-butadiene emulsion; and (iv) about 0 wt % to about 55 wt % at least one additive.

The amount of the acrylic copolymer emulsion present in the water-based humidity resistant adhesive composition is about 30 wt % to about 35 wt %, about 35 wt % to about 40 wt %, about 40 wt % to about 45 wt %, about 45 wt % to about 50 wt %, about 50 wt % to about 55 wt %, about 55 wt % to about 60 wt %, about 60 wt % to about 65 wt %, about 65 wt % to about 70 wt %, about 70 wt % to about 75 wt %, about 75 wt % to about 80 wt %.

According to one embodiment, the acrylic copolymer comprises monomers of C₂-C₂₀ alkyl acrylates, C₂-C₂₀ alkyl methacrylates and vinyl acetate.

According to one more embodiment, the acrylic copolymer comprises monomers of C₂-C₅ alkyl acrylates, C₆-C₁₀ alkyl acrylates, C₁₁-C₁₅ alkyl acrylates, C₁₆-C₂₀ alkyl acrylates, C₂-C₂₀ alkyl methacrylates, C₂-C₅ alkyl methacrylates, C₆-C₁₀ alkyl methacrylates, C₁₁-C₁₅ alkyl methacrylates, C₁₆-C₂₀ alkyl methacrylates and vinyl acetate.

According to another embodiment, the acrylic copolymer comprises monomers of 2-ethylhexyl acrylate, vinyl acetate, and methyl methacrylate.

According to one more embodiment, the acrylic copolymer comprises monomers in the range of from about 60 wt % to about 98 wt % of 2-ethylhexyl acrylate, from about 1 wt % to about 15 wt % vinyl acetate, and from about 1 wt % to about 15 wt % methyl methacrylate.

According to one more embodiment, the amount of 2-ethylhexyl acrylate in acrylic copolymer ranges from about 60 wt % to about 98 wt %.

According to one more embodiment, the amount of 2-ethylhexyl acrylate in the acrylic copolymer ranges from about 60 wt % to about 65 wt %, about 66 wt % to about 70 wt %, about 71 wt % to about 75 wt %, about 76 wt % to about 80 wt %, about 81 wt % to about 85 wt %, about 86 wt % to about 90 wt %, about 91 wt % to about 95 wt %, or about 96 wt % to about 98 wt %.

According to one more embodiment, the amount of vinyl acetate in the acrylic copolymer ranges from about 1 wt % to about 15 wt %.

According to one more embodiment, the amount of vinyl acetate in acrylic copolymer ranges from about 1 wt % to about 15 wt %, about 6 wt % to about 10 wt %, or about 11 wt % to about 15 wt %.

According to one more embodiment, the amount of methyl methacrylate in the acrylic copolymer ranges from about 1 wt % to about 15 wt %.

According to one more embodiment, the amount of methyl methacrylate in the acrylic copolymer ranges from about 1 wt % to about 15 wt %, about 6 wt % to about 10 wt %, or about 11 wt % to about 15 wt %.

According to one of the embodiments, the acrylic copolymer has a glass transition temperature (T_{g}) in the range of from about −80° C. to about −20° C.

According to one more embodiment, the acrylic copolymer has a glass transition temperature (T_{g}) in the range of from about −80° C. to about −75° C., about −74° C. to about −70° C., about −69° C. to about −65° C., about −64° C. to about −60° C., about −59° C. to about −55° C., about −54° C. to about −50° C., about −49° C. to about −45° C., about −44° C. to about −40° C., about −39° C. to about −35° C., about −34° C. to about −30° C., about −29° C. to about −25° C., about −24° C. to about −20° C.

According to another embodiment, the acrylic copolymer has a solids content in the range of from about 50% to about 90%.

According to one more embodiment, the acrylic copolymer has a solids content in the range of from about 50% to about 55%, about 56% to about 60%, about 61% to about 65%, about 66% to about 70%, about 71% to about 75%, about 76% to about 80%, about 81% to about 85%, or about 86% to about 90%.

According to one of the embodiments, the acrylic copolymer is sold by Ashland LLC under the tradename of Flexcryl® in a variety of ranges.

According to one more embodiment, the acrylic copolymer emulsions are suitably prepared by conventional emulsion polymerization conditions for preparing aqueous acrylic PSA emulsions. Representative of such emulsion techniques are duly disclosed in the following non-limiting U.S. Pat. Nos. 4,371,659 and 4,424,298 which are incorporated by reference in its entirety.

According to one more embodiment, the water-based humidity resistant adhesive composition has about 2 wt % to about 40 wt % of an adhesion promoter of a water-based chlorinated or maleic anhydride modified polyolefin.

According to one more embodiment, the amount of adhesion promoter of water-based chlorinated or maleic anhydride modified polyolefin present in the water-based humidity resistant adhesive composition is about 2 wt % to about 5 wt %, about 6 wt % to about 10 wt %, about 11 wt % to about 15 wt %, about 16 wt % to about 20 wt %, about 21 wt % to about 25 wt %, 26 wt % to about 30 wt %, 31 wt % to about 35 wt %, 36 wt % to about 40 wt %.

According to one more embodiment, the water-based humidity resistant adhesive composition has carboxylated styrene-butadiene emulsion present in an amount of from about 1 wt % to about 20 wt %.

According to another embodiment, the water-based humidity resistant adhesive composition has carboxylated styrene-butadiene emulsion present in an amount of from about 1 wt % to about 5 wt %, 6 wt % to about 10 wt %, 11 wt % to about 15 wt %, 16 wt % to about 20 wt %.

According to one more embodiment, the examples of commercially available styrene butadiene latex binders which can be used in the water-based humidity resistant adhesive composition of the present invention include styrene butadiene latexes in the Rovene® range supplied by Mallard Creek polymers such as Rovene® 4002, Rovene 4009, Rovene® 4011, Rovene® 4151, Rovene® 4541, Rovene® 5049, Rovene® 5499, ROVENE® 5550, Rovene 5900, Rovene 6102, Rovene 6103, Rovene 6104, Rovene 6201, Rovene 6202, Rovene®6521, Rovene 8001 and Rovene 8002.

According to another embodiment, the carboxylated styrene-butadiene emulsion has a solids content of from about 30% to about 70%.

According to one more embodiment, the carboxylated styrene-butadiene emulsion has a solids content of from about 30% to about 35%, from about 36% to about 40%, from about 41% to about 45%, from about 46% to about 50%, from about 51% to about 55%, from about 56% to about 60%, from about 61% to about 65%, from about 66% to about 70%.

According to one more embodiment, the water-based humidity resistant adhesive composition comprises an additive selected from the group consisting of a tackifier, a rheology modifier, a surfactant, a wetting agent, a crosslinking agent, a neutralizer, pH adjustment agent, a pigment, an extender and a filler.

The water-based humidity resistant adhesive composition generally includes such additive(s) present in an amount of from about 20 wt % to about 55 wt %.

According to one more embodiment, the carboxylated styrene-butadiene emulsion has a solids content of from about 20% to about 25%, from about 26% to about 30%, from about 31% to about 35%, from about 36% to about 40%, from about 41% to about 45%, from about 46% to about 50%, or from about 51% to about 55%.

According to one more embodiment, the tackifier may be aromatic and can be selected from the group consisting of rosin and its esters, terpene resins, aromatic hydrocarbon resins and aliphatic hydrocarbon resins.

According to one more embodiment, the aromatic tackifier resins can be incorporated in the current water-based humidity resistant adhesive compositions in accordance with any known means, such as those exemplified in U.S. Pat. Nos. 4,414,346, 4,486,563 and 4,487,873. Typically the aromatic tackifier resin is emulsified in water and added directly to the water-based humidity resistant adhesive compositions.

According to another embodiment, the tackifier is present in an amount of from about 10 wt % to 45 wt %.

According to one more embodiment, the tackifier is present in an amount of from about 10 wt % to about 15 wt %, from about 15 wt % to about 20 wt %, from about 20 wt % to about 25 wt %, from about 25 wt % to about 30 wt %, from about 35 wt % to about 40 wt %, or from about 40 wt % to about 45 wt %.

According to one more embodiment, the water-based humidity resistant adhesive composition of the invention can also include one or more rheology modifiers to control the flow of the adhesive composition. Useful rheology modifiers include, but are not limited to, alkali soluble or swellable emulsions such as Acrysol™ ASE-60, ASE-75, and ASE-95NP, Acusol™ 810A (Rohm and Haas, Philadelphia, Pa.) and Alcogum™ L-15, L-131, and L-37 (Alco Chemical, Chattanooga, Tenn.), alkali soluble associative emulsions such as Alcogum™ SL-70, and 78 (Alco Chemical) or Acrysol™ TT-935 or RM-5 (Rohm and Haas), and alkali swellable associative urethanes such as Polyphobe™ P-104, and P-106 (Union Carbide, Cary, N.C.) and in addition, hydrophobically-modified associative polyurethane dispersions such as NopCo™ DSX 1514 and 1550, (Henkel Corporation, Ambler, Pa.) and Acrysol™ RM-825, RM 1020, RM 8W (Rohm and Haas). Another useful rheology modifier is Rheovis PU 1250 from BASF.

According to one of the embodiments, emulsifiers or surfactants are included to improve stability of the water-based humidity resistant adhesive composition. The emulsifiers or surfactants contemplated for the invention include any of the known and conventional surfactants and emulsifying agents, the nonionic materials; polyalkoxylated surfactants. Useful surfactants include, but are not limited to, Triton series emulsifiers from Dow Chemical. Among the nonionic surfactants found to provide good results are the Igepal surfactants supplied by Rhodia. The Igepal surfactants are members of a series of alkylphenoxy-poly(ethyleneoxy)ethanois having alkyl groups containing from about 7-18 carbon atoms, and having from about 4 to 100 ethyleneoxy units (can be 10 to 30 mol of ethyleneoxy groups), such as the octylphenoxy poly(ethyleneoxy)ethanols, nonylphenoxy poly(ethyleneoxy)ethanols, and dodecylphenoxy poly(ethyleneoxy)ethanols. Examples of other nonionic surfactants include polyoxyalkylene derivatives of hexitol (including sorbitans, sorbides, manitans, and mannides) anhydride, partial long-chain fatty acid esters, such as polyoxyalkylene derivatives of sorbitan monolaurate, sorbitan monopalmitate, sorbitan monostearate, sorbitan tristearate, sorbitan monooleate and sorbitan trioleate. When used, the amount of emulsifier present in the water-based humidity resistant adhesive composition is 0.01 to 1 wt %, according to another embodiment, is 0.05 to 0.5 wt %, based on the adhesive solids in the water-based humidity resistant adhesive composition.

As used herein, the term wetting agent means a compound having a hydrophobic fraction and a hydrophilic fraction and includes a surfactant, a gas bubble destabilizing agent and an antifoaming agent. According to one of the embodiments the wetting agents are ethoxylated acetylenic surfactants. Examples of wetting agents that are suitable for the current invention include, but are not limited to, Surfynol® 440 (Evonik), Tego Wet 250 (Tego Chemie Service USA), Tego Wet 260 (Tego Chemie Service USA).

In some, embodiments, the water-based humidity resistant adhesive composition disclosed herein comprises a crosslinking agent and an additive that induces or enhances crosslinking. In some embodiments, the additive that can induce or enhance crosslinking is a cationic additive that can induce ionic crosslinking with the copolymers disclosed herein. Exemplary cationic additives include, but are not limited to, ammonium zirconium carbonate, zirconium acetate, and amines such as diallyl dimethyl ammonium chloride.

Commercially available ionic crosslinking agents include, but are not limited to, BACOTE-20®, PROTEC® ZZA, and ZINPLEX-15®. The amount of the ionic crosslinking agent can be adjusted, for instance, based on the desired extent of the complexation of the acid groups on the polymer at a given pH. In some embodiments, the composition includes 0.01% to 5% by weight (e.g., 0.05%-4.5%, 1%-4%, 1.5%-3.5%, or 2%-3%) of the ionic crosslinking agent, based on the total weight of the solids (which can be roughly equivalent the weight of the polymer).

According to one of the embodiments, the pH adjustment agents useful for the current invention include, but are not limited to, amines, such as ammonia, diethylenetriamine and triethylenetetramine.

According to one of the embodiments, one or more fillers are included to the water-based humidity resistant adhesive composition. Generally, any compatible filler, such as calcium carbonate may be employed if desired for a particular application. As the skilled person will appreciate, fillers will generally be omitted when the water-based humidity resistant adhesive composition is intended to be sprayed onto one surface that is subsequently applied to a second surface on which the adhesive is or is not deposited. Fillers useful for the current invention include, but are not limited to, kaolin and talc.

According to one more embodiment, the method of bonding a sheet membrane to a substrate comprises applying a water-based humidity resistant adhesive composition to the substrate, the water based adhesive composition comprising: (i) about 30 wt % to about 80 wt % of an acrylic copolymer emulsion; (ii) about 2 wt % to about 40 wt % of an adhesion promoter of a water-based chlorinated or maleic anhydride modified polyolefin; (iii) about 0 to about 25 wt % of carboxylated styrene-butadiene emulsion; and (iv) about 0 wt % to about 55 wt % of at least one additive, and bringing the sheet membrane and the substrate in simultaneous contact with the water-based humidity resistant adhesive composition to bond the sheet membrane to the substrate.

According to one more embodiment, the method of bonding a sheet membrane to a substrate comprises applying the water-based humidity resistant adhesive composition by roller, brush, or spray.

The sheet membrane used in the practice of the present invention can be plain-backed or fleece-backed. According to one more embodiment, the method of bonding a sheet membrane to a substrate comprises applying the above-described water-based humidity resistant adhesive composition to at least one substrate, mating the sheet membrane and the substrate together and bonding them together immediately thereafter.

According to another embodiment, the roofing substrate is selected from a steel, wood or concrete roofing deck, a roof board, insulation, or a fiberglass mat roof board. Such substrates are conventional and well known to those skilled in the roofing art.

The sheet membrane according to current invention is selected from the group consisting of weathered thermoplastic polyolefin (TPO), new thermoplastic polyolefin, patched thermoplastic polyolefin, new modified bitumen, weathered modified bitumen, weathered silicone rubber roof coating, polypropylene and ethylene propylene diene terpolymer rubber (EPDM).

According to one more embodiment, the present invention discloses a process for preparing a water-based humidity resistant adhesive composition, comprising: (i) charging acrylic copolymer emulsion into a reaction container, initiating agitation and mixing; (ii) adding a crosslinking agent, neutralizer or pH adjustment agent to the resultant of step (i) in one or more steps and mixing for at least 10 minutes after each addition; (iii) adding a carboxylated styrene-butadiene emulsion, and an adhesion promoter of water-based chlorinated or maleic anhydride modified polyolefins to the resultant of step (ii); (iv) adding a tackifier to the resultant of step (iii); (v) adding a pre-blend solution comprising complexed zinc oxide solution and deionized water to the resultant of step (iv); (vi) adding a surfactant, to the resultant of step (v); and (vii) adding a rheology modifier to the resultant of step (v) to obtain the water-based humidity resistant adhesive composition.

### Examples

The invention is described with reference to the following examples, in a non-limiting manner. The following examples exemplify the water-based humidity resistant adhesive composition for bonding a sheet membrane to a substrate, a method of bonding to a substrate with the composition, a method of preparing the composition thereof described herein. The examples are for the purposes of illustration only and are not intended to be limiting. Many variations will suggest themselves and are within the full intended scope.

Adhesion samples were bonded between TPO membrane and plywood. 9″×12″ samples were bonded and stationed for 1 day at ambient condition. They are then subjected to conditioning at both room temperature (RT, 72° F.) and humid (140° F./95% RH) conditioning. Samples are taken out of the conditioning chamber and recover at RT for around 3 hours. 1″ wide TPO membrane was cut to conduct 180-degree peel test on Instron. Test minimum two Peel Tests at 2″/minute traveling a minimum 4″ and record results, industrial requirements are 4 pli (pounds per linear inch) for RT adhesion and 2 pli for Humid adhesion at all testing dates.

TABLE 1
Composition and adhesion of Comparative examples

| | Comparative | Comparative | Comparative | Comparative | Comparative | Comparative | Comparative |
|---|---|---|---|---|---|---|---|
| Ingredients | Example 1 | Example 2 | Example 3 | Example 4 | Example 5 | Example 6 | Example 7 |
| Flexcryl 1625 | 94.89 | 58.52 | 69.18 | 53.10 | 34.59 | 28.09 | 59.18 |
| Duroset C310 | — | 18.74 | — | — | — | 13.00 | — |
| Purethane 4002 | | | | | 34.59 | 28.09 | |
| Aquatac E-6180 | — | 19.32 | 19.32 | 35.40 | 19.32 | 19.32 | 19.32 |
| Zinplex 15 | 1.45 | 0.59 | 0.59 | 0.59 | 0.59 | 0.59 | 0.59 |
| DI water | 1.45 | 0.59 | 0.59 | 0.59 | 0.59 | 0.59 | 0.59 |
| Hardlen EW-5303 | 1.89 | 1.93 | 10.00 | 10.00 | 10.00 | 10.00 | 20.00 |
| Surfynol 440 | 0.12 | 0.12 | 0.12 | 0.12 | 0.12 | 0.12 | 0.12 |
| Rheovis PU 1214 | 0.20 | 0.20 | 0.20 | 0.20 | 0.20 | 0.20 | 0.20 |
| Total | 100.00 | 100.00 | 100.00 | 100.00 | 100.00 | 100.00 | 100.00 |
| Adhesion, 72° F. - Day 1 (pli) | 4.9 | 9.2 | 6.8 | 11.5 | 5.5 | 5.7 | 5.4 |
| Adhesion, 72° F. - Day 7 (pli) | 4.1 | 7.2 | 5.1 | 11.7 | 4.8 | 3.0 | 5.2 |
| Adhesion, 72° F. - Day 14 (pli) | 4.1 | 6.9 | 6.2 | 5.0 | 2.5 | 1.5 | 7.1 |
| Adhesion, 72° F. - Day 28 (pli) | 4.2 | 7.7 | 5.1 | 4.7 | 1.1 | 1.3 | 4.8 |
| Adhesion, 140° F./95% RH - | 5.4 | 6.1 | 6.0 | 11.5 | 5.3 | 7.1 | 7.2 |
| Day 1 (pli) | | | | | | | |
| Adhesion, 140° F./95% RH - | 0.1 | 0.3 | 0.4 | 4.7 | 4.8 | 6.4 | 4.9 |
| Day 7 (pli) | | | | | | | |
| Adhesion, 140° F./95% RH - | 0.1 | 0.2 | 0.5 | 3.8 | 4.3 | 4.4 | 3.5 |
| Day 14 (pli) | | | | | | | |
| Adhesion, 140° F./95% RH - | 0.0 | 0.2 | 0.1 | 1.5 | 4.3 | 5.5 | 1.1 |
| Day 28 (pli) | | | | | | | |

Composition and adhesion of Comparative Examples are presented in Table 1 and also in FIGS. 1 and 2. Acrylic copolymer emulsion (Flexcryl 1625) has decent bonding performance at room temperature to TPO membrane, as illustrated by Comparative Example 1. However, the adhesion is not robust against humid (140° F./95% RH) conditioning. After only 7 days in humid condition, the adhesion dropped sharply to almost none. Various ideas have been trialed to improve adhesion at both RT and Humid conditions, for Example, introducing a rosin ester tackifier (Aquatac E-6180) and a complexed zinc oxide (Zinplex 15). Comparative Example 2 illustrates a formulation containing a blend of an acrylic copolymer emulsion (Flexcryl 1625) and a polyvinyl acetate emulsion (Duroset C310). Its adhesion at RT is improved greatly, however, the adhesion after Humid conditioning is still very poor. Comparative Example 3 illustrates a formulation containing higher loading of an adhesion promoter of water-based chlorinated or maleic anhydride modified polyolefins (Hardlen EW-5303) than that in Comparative Example 1. The RT adhesion is improved slightly, but no significant improvement for Humid adhesion. Comparative Example 4 illustrates a formulation containing higher loading of both tackifier and adhesion promoter than those in Comparative Example 1. The adhesion after both RT and Humid conditioning is improved significantly, especially the initial (1-day) adhesion. However, its long-term RT adhesion has a decreasing trend, which is not desirable for field applications. Blending with a hydrolysis resistant polyurethane dispersion (Purethane 4002) were trialed for both co-blend with acrylic copolymer emulsion and tri-blend with acrylic copolymer emulsion and polyvinyl acetate emulsion, as illustrated in Comparative example 5 and 6. Adhesion after humid conditioning are improved significantly, however, RT adhesion is not satisfactory and also has a decreasing trend. Comparative example 7 illustrates a formulation containing 20% of adhesion promoter, higher loading than that in both Comparative example 1 and 3. RT adhesion is decent and adhesion after humid conditioning is improved significantly, although it is still not high enough to meet the industrial requirement of at least 2 pli after 28 days.

TABLE 2
Composition and adhesion of Examples

| Ingredients | Example 1 | Example 2 | Example 3 | Example 4 |
|---|---|---|---|---|
| Flexcryl 1625 | 49.18 | 39.18 | 46.37 | 44.04 |
| Rovene 5049 | — | — | 15.06 | 14.30 |
| Aquatac E-6180 | 19.32 | 19.32 | 30.11 | 28.60 |
| Zinplex 15 | 0.59 | 0.59 | 0.59 | 0.59 |
| DI water | 0.59 | 0.59 | 0.59 | 0.59 |
| Hardlen EW-5303 | 30.00 | 40.00 | — | — |
| AdvaBond 7200 | — | — | 6.00 | 10.00 |
| Triethylenetetramine | — | — | 0.28 | 0.28 |
| IGEPAL CO 887 | — | — | 0.50 | 0.50 |
| Surfynol 440 | 0.12 | 0.12 | — | 0.12 |
| Rheovis PU 1214 | 0.20 | 0.20 | — | 0.98 |
| Rheovis PU 1250 | — | — | 0.50 | — |
| Total | 100.00 | 100.00 | 100.00 | 100.00 |
| Adhesion, 72° F. - Day 1 (pli) | 5.8 | 4.8 | 12.2 | 12.2 |
| Adhesion, 72° F. - Day 7 (pli) | 6.3 | 5.7 | 14.8 | 15.0 |
| Adhesion, 72° F. - Day 14 (pli) | 8.1 | 6.2 | 15.8 | 15.5 |
| Adhesion, 72° F. - Day 28 (pli) | 7.2 | 5.5 | 15.2 | 16.6 |
| Adhesion, 140° F./95% RH - Day 1 | 6.4 | 5.7 | 10.5 | 11.0 |
| (pli) | | | | |
| Adhesion, 140° F./95% RH - Day 7 | 4.9 | 4.4 | 11.0 | 12.3 |
| (pli) | | | | |
| Adhesion, 140° F./95% RH - Day 14 | 4.4 | 5.1 | 10.0 | 13.4 |
| (pli) | | | | |
| Adhesion, 140° F./95% RH - Day 28 | 2.7 | 5.0 | 7.8 | 11.3 |
| (pli) | | | | |

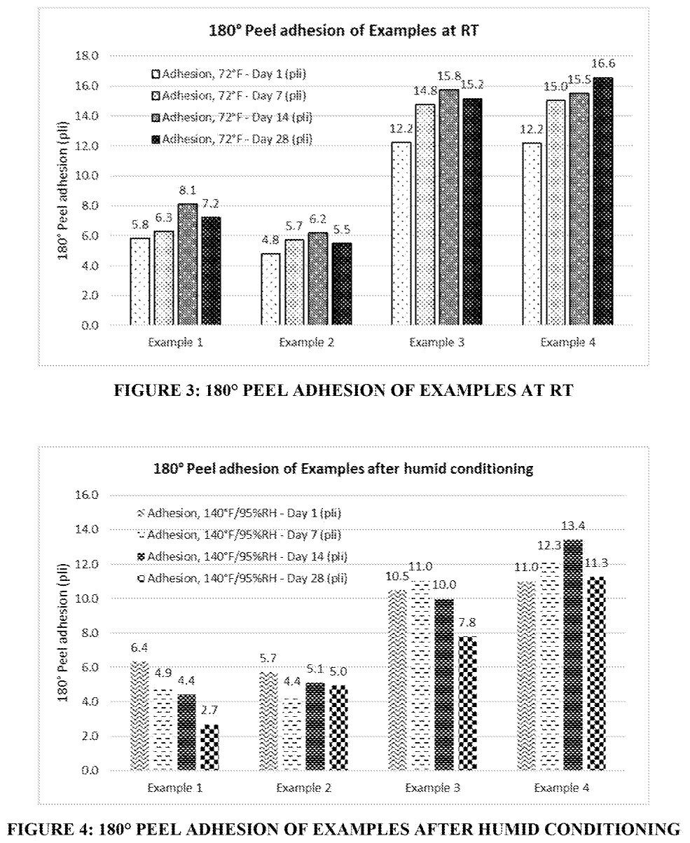

Composition and adhesion of Examples are presented in Table 2 and also in FIGS. 3 and 4. Example 1 and 2 illustrate formulations containing 30% and 40% adhesion promoter, higher than the 20% in Comparative Example 7. Adhesion after RT conditioning is decent, and adhesion after humid conditioning is improved significantly to the level of meeting commercial industrial requirements. Example 3 and 4 illustrate formulations containing a co-blending resin of carboxylated styrene-butadiene emulsion (Rovene 5049), and also a lower concentration of another adhesion promoter of water-based chlorinated or maleic anhydride modified polyolefins (AdvaBond 7200). Their adhesion after RT and humid conditioning is superb and very stable, greatly exceeding the industrial requirement.

While this invention has been described in detail with reference to certain preferred embodiments, it should be appreciated that the present invention is not limited to those precise embodiments. Rather, in view of the present disclosure, many modifications and variations would present themselves to those skilled in the art without departing from the scope and spirit of this invention.

1. A water-based humidity resistant adhesive composition comprising:
i) about 30 wt % to about 80 wt % of an acrylic copolymer emulsion;
ii) about 2 wt % to about 40 wt % of an adhesion promoter of a water-based chlorinated or maleic anhydride modified polyolefin;
iii) about 1 wt % to about 20 wt % of carboxylated styrene-butadiene emulsion; and
iv) about 0 wt % to about 55 wt % of at least one additive.

2. The water-based humidity resistant adhesive composition according to claim 1, wherein the acrylic copolymer comprises monomers of C₂-C₂₀ alkyl acrylates, C₂-C₂₀ alkyl methacrylates and vinyl acetate.

3. The water-based humidity resistant adhesive composition according to claim 1, wherein the acrylic copolymer comprises monomers of 2-ethylhexyl acrylate, vinyl acetate, and methyl methacrylate.

4. The water-based humidity resistant adhesive composition according to claim 3, wherein the acrylic copolymer comprises monomers in the range of from about 60 wt % to about 98 wt % of 2-ethylhexyl acrylate, from about 1 wt % to about 15 wt % vinyl acetate, and from about 1 wt % to about 15 wt % methyl methacrylate.

5. The water-based humidity resistant adhesive composition according to claim 3, wherein the acrylic copolymer further comprising monomers selected from the group consisting of styrene, acrylic acid and hydroxypropyl acrylate.

6. The water-based humidity resistant adhesive composition according to claim 1, wherein the acrylic copolymer has a glass transition temperature (T_{g}) in the range of from about −80° C. to about −20° C.

7. The water-based humidity resistant adhesive composition according to claim 1, wherein the acrylic copolymer has a solids content in the range of from about 50% to about 90%.

8. The water-based humidity resistant adhesive composition according to claim 1, wherein the composition comprises about 10 wt % to about 30 wt % of an adhesion promoter of a water-based chlorinated or maleic anhydride modified polyolefin.

9. (canceled)

10. The water-based humidity resistant adhesive composition according to claim 1, wherein the carboxylated styrene-butadiene emulsion has a solids content of from about 30% to about 70%.

11. The water-based humidity resistant adhesive composition according to claim 1, wherein the additive is selected the group consisting of a tackifier, a rheology modifier, a surfactant, a wetting agent, a crosslinking agent, a neutralizer, pH adjustment agent, a pigment, an extender and a filler.

12. The water-based humidity resistant adhesive composition according to claim 11, wherein the additive is present in an amount of from about 20 wt % to about 55 wt %.

13. The water-based humidity resistant adhesive composition according to claim 11, wherein the tackifier is selected from the group consisting of rosin and its esters, terpene resins, aromatic hydrocarbon resins and aliphatic hydrocarbon resins.

14. The water-based humidity resistant adhesive composition according to claim 13, wherein the tackifier is present in an amount of from about 10 wt % to 45 wt %.

15. A method of bonding a sheet membrane to a substrate comprising:
applying a water-based humidity resistant adhesive composition to the substrate, said water based adhesive composition comprising:
i) about 30 wt % to about 80 wt % of an acrylic copolymer emulsion;
ii) about 2 wt % to about 40 wt % of an adhesion promoter of a water-based chlorinated or maleic anhydride modified polyolefin;
iii) about 1 to about 20 wt % of carboxylated styrene-butadiene emulsion; and
iv) about 0 wt % to about 55 wt % of at least one additive, and
bringing the sheet membrane and the substrate in simultaneous contact with said water based adhesive composition to bond the sheet membrane to the substrate.

16. The method according to claim 15, wherein the adhesive composition is applied to the substrate by roller, brush, or spray.

17. The method according to claim 15, wherein the sheet membrane is fleece-backed or plain-backed.

18. The method according to claim 15, wherein the adhesive composition is applied to the substrate, and the sheet membrane and the substrate are mated and bonded together immediately.

19. The method according to claim 15, wherein the substrate is selected from the group consisting of steel, wood, concrete, roof board, insulation and fiberglass mat.

20. The method according to claim 15, wherein the sheet membrane is selected from the group consisting of weathered thermoplastic polyolefin (TPO), new thermoplastic polyolefin, patched thermoplastic polyolefin, new modified bitumen, weathered modified bitumen, weathered silicone rubber roof coating, polypropylene and ethylene propylene diene terpolymer rubber (EPDM).

21. A process for preparing a water-based humidity resistant adhesive composition, comprising:
i) charging acrylic copolymer emulsion into a reaction container, initiating agitation and mixing;
ii) adding a crosslinking agent, neutralizer or pH adjustment agent to the resultant mixture of step (i) in one or more steps and mixing for at least 10 minutes after each addition;
iii) adding a carboxylated styrene-butadiene emulsion and an adhesion promoter of a water-based chlorinated or maleic anhydride modified polyolefin to the resultant mixture of step (ii);
iv) adding a tackifier to the resultant mixture of step (iii);
v) adding a pre-blended solution comprising complexed zinc oxide solution and deionized water to the resultant mixture of step (iv);
vi) adding a surfactant to the resultant mixture of step (v); and
vii) adding a rheology modifier to the resultant mixture of step (v) to obtain the water-based humidity resistant adhesive composition.
